(19) United States
(12) Patent Application Publication
(10) Pub. No.: US 2026/0241984 A1
(43) Pub. Date: Aug. 20, 2026

(54) STEERING ANGLE CONTROL APPARATUS

(71) Applicant: Honda Motor Co., Ltd., Tokyo (JP)

(72) Inventors: Yuta Tsurumoto, Tokyo (JP); Kazuki Tomioka, Tokyo (JP)

(21) Appl. No.: 19/538,882

(22) Filed: Feb. 12, 2026

(30) Foreign Application Priority Data
Feb. 14, 2025 (JP) 2025-022429

(51) Int. Cl. B62D 5/04; B62D 5/00; B62D 7/15; B62D 15/02

(52) U.S. Cl. CPC B62D 5/0463; B62D 5/008; B62D 7/159; B62D 15/021; B62D 15/0235

(57) ABSTRACT

A steering angle control apparatus performs: acquiring vehicle state quantities indicating a motion state of a vehicle from an in-vehicle sensor; predicting a behavior of the vehicle based on the quantities; calculating a steering angle instruction value for a steering actuator using the prediction result; estimating a disturbance component of a steering angle based on the quantities; calculating a first correction amount of the steering angle based on the estimation result; calculating a cant-angle compensation steering angle based on the quantities; and calculating a second correction amount of the steering angle based on the cant-angle compensation steering angle. The apparatus performs correcting the steering angle included in the quantities used for prediction of the vehicle behavior, based on a third correction amount obtained by merging the first and second correction amounts, and outputting the steering angle instruction value corrected based on the third correction amount.

### CROSS-REFERENCE TO RELATED APPLICATION

This application is based upon and claims the benefit of priority from Japanese Patent Application No. 2025-022429 filed on Feb. 14, 2025, the content of which is incorporated herein by reference.

### BACKGROUND

### Technical Field

The present invention relates to a steering angle control apparatus for controlling a steering angle of a vehicle.

### Related Art

In recent years, efforts to provide access to sustainable transportation systems in consideration of vulnerable people among traffic participants are becoming active. In order to achieve this, efforts are being focused research and development for further improving traffic safety and convenience through research and development regarding driving assistance techniques. As this type of device, conventionally, there is known a device that determines auxiliary torque to be added to a steering system so as to remove disturbance torque corresponding to a change in a road surface condition (see JP 2002-154450 A). In the device described in JP 2002-154450 A, the auxiliary torque is determined by feedback control based on a deviation between the steering wheel torque acting on a steering wheel and the steering torque detected by a steering torque sensor provided in the middle of a steering system.

However, since the degree of change in the road surface condition varies depending on the location, if the auxiliary torque is determined by feedback control as in the device described in JP 2002-154450 A, there is a possibility that high responsiveness to the change in the road surface condition cannot be obtained.

### SUMMARY

An aspect of the present invention is a steering angle control apparatus including: a microprocessor; and a memory connected to the microprocessor. The microprocessor is configured to perform: acquiring vehicle state quantities indicating a motion state of a vehicle based on a sensor value of an in-vehicle sensor; predicting a behavior of the vehicle based on the vehicle state quantities acquired; calculating a steering angle instruction value for a steering actuator of the vehicle using a result of the predicting so as to maintain a traveling state where the vehicle travels along a target route; estimating a disturbance component of a steering angle of the vehicle base on the vehicle state quantities; calculating a first steering angle correction amount based on a result of the estimating; calculating a steering angle compensating for a cant angle of a road surface, which is a part of the disturbance component, based on the vehicle state quantities; and calculating a second steering angle correction amount based on a result of the calculating of the steering angle. The microprocessor is configured to perform the predicting including correcting the steering angle included in the vehicle state quantities used for prediction of the vehicle behavior, based on a third steering angle correction amount obtained by merging the first steering angle correction amount and the second steering angle correction amount. The microprocessor is configured to further perform outputting, to the steering actuator, the steering angle instruction value corrected based on the third steering angle correction amount.

### BRIEF DESCRIPTION OF THE DRAWINGS

The objects, features, and advantages of the present invention will become clearer from the following description of embodiments in relation to the attached drawings, in which:

FIG. 1 is a block diagram illustrating a configuration of a vehicle control system including a steering angle control apparatus according to an embodiment of the present invention;

FIG. 2 is a block diagram illustrating a main configuration of a steering angle control apparatus;

FIG. 3A is a block diagram for explaining a flow of steering angle control;

FIG. 3B is a block diagram for explaining details of the steering angle control unit in FIG. 3A;

FIG. 3C is a diagram for explaining a fusion steering angle disturbance;

FIG. 4 is a flowchart illustrating an example of computation processing executed by the processing unit in FIG. 2;

FIG. 5A is a diagram illustrating an example of a travel scene of a subject vehicle;

FIG. 5B is a diagram illustrating a steering angle correction amount corresponding to the travel scene of FIG. 5A;

FIG. 6A is a diagram illustrating another example of a travel scene of a subject vehicle; and

FIG. 6B is a diagram illustrating a steering angle correction amount corresponding to the travel scene of FIG. 6A.

### DETAILED DESCRIPTION

Hereinafter, embodiments of the invention will be described below with reference to the drawings.

A steering angle control apparatus according to an embodiment of the present invention controls a steering angle of a steering apparatus (for example, a power steering apparatus) of a vehicle as a control target, such that the vehicle follows a target route (which may also be referred to as a target path). The steering angle control apparatus can be applied to both a manual driving vehicle equipped with ADAS (Advanced Driver-Assistance Systems) and a vehicle having a self-driving capability, that is, a self-driving vehicle, but for the sake of convenience of description, a case where the steering angle control apparatus is applied to a self-driving vehicle will be described below as an example.

Furthermore, in the embodiment, a vehicle on which the steering angle control apparatus is mounted may be referred to as a subject vehicle to be distinguished from other vehicles. The subject vehicle may be any of an engine vehicle having an internal combustion engine (engine) as a traveling drive source, an electric vehicle having a traveling motor as a traveling drive source, and a hybrid vehicle having an engine and a traveling motor as a traveling drive source. The subject vehicle is capable of traveling not only in a self-drive mode that does not require a driver’s driving operation but also traveling in a manual drive mode that requires a driver’s driving operation.

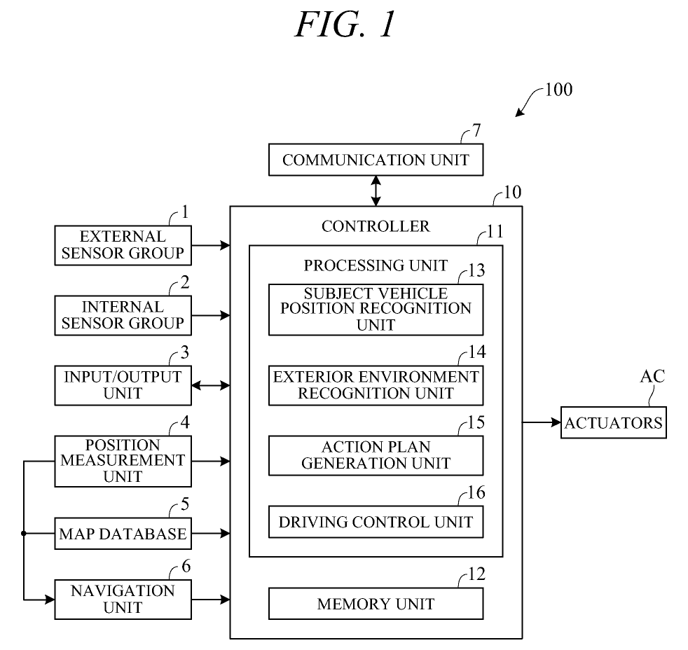

First, a schematic configuration of the subject vehicle related to self-driving will be described. FIG. 1 is a block diagram illustrating a configuration of a vehicle control system 100 of a subject vehicle including the steering angle control apparatus according to the embodiment. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC, each of which is communicably connected with the controller 10.

The “external sensor group 1” is a generic term for a plurality of sensors (external sensors) that detect an external situation that is surrounding information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by irradiating electromagnetic waves and detecting reflected waves, and a camera or the like that is installed in the subject vehicle, has an imaging element (image sensor) such as a charge coupled device (CCD) or a complementary metal oxide semiconductor (CMOS) sensor, and captures images of the surrounding (front, rear, and side) of the subject vehicle.

The “internal sensor group 2” is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction (advancing direction) of the subject vehicle and an acceleration (lateral acceleration) in a left-right direction (lane width direction) of the subject vehicle, a revolution sensor that detects the number of revolutions of the traveling drive source, and a yaw rate sensor or the like that detects a rotation angle speed around a vertical axis of the center of gravity of the subject vehicle. The internal sensor group 2 also includes sensors that detect a driver's driving operation such as an operation on an accelerator pedal, an operation on a brake pedal, or an operation on a steering wheel in the manual drive mode.

The “input/output device 3” is a generic term for devices to and from which a command is input by a driver or information is output to the driver. For example, the input/output device 3 includes various switches to which a driver inputs various commands by operating an operation member, a microphone to which the driver inputs commands with voice, a display that provides information to the driver via a display image, a speaker that provides information to the driver with voice, and the like.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information to be used by the navigation unit 6, and includes, for example, a magnetic disk or a semiconductor element. The map information includes road position information, information regarding a road shape (a curvature or the like), and position information regarding intersections and branch points. Note that the map information stored in the map database 5 is different from high-precision map information stored in a memory unit 12 of the controller 10.

For example, the navigation unit 6 is a device that searches for a route on roads to a destination that has been input by a driver and that performs travel guidance along the route. The input of the destination and the travel guidance along the searched route are made via the input/output device 3. The route search is performed based on the current position of the subject vehicle measured by the position measurement unit 4, the input destination position, and the map information stored in the map database 5. It is possible to measure the current position of the subject vehicle using detection values of the external sensor group 1, and the route may be searched for, based on the current position and the high-precision map information stored in the memory unit 12.

The communication unit 7 communicates with various servers not illustrated via a network including wireless communication networks represented by the Internet, a mobile telephone network, and the like, and acquires the map information, travel history information, traffic information, and the like from the servers periodically or at an arbitrary timing. The travel history information of the subject vehicle may be transmitted to the server via the communication unit 7 in addition to the acquisition of the travel history information. The network includes not only a public wireless communication network but also a closed communication network provided for every predetermined management area, for example, a wireless LAN, Wi-Fi (registered trademark), Bluetooth (registered trademark), and the like. The acquired map information is output to the map database 5 and the memory unit 12, and the map information is updated.

The actuator AC is a traveling actuator for controlling traveling of the subject vehicle. In a case where the traveling drive source is an engine, the actuator AC includes a throttle actuator that adjusts an opening degree (a throttle opening degree) of a throttle valve of the engine. In a case where the traveling drive source is a traveling motor, the traveling motor is included in the actuator AC. The actuator AC also includes a braking actuator that actuates a braking device of the subject vehicle and a steering actuator that actuates a steering apparatus.

The controller 10 includes an electronic control unit (ECU). More specifically, the controller 10 is configured to include a computer including a processing unit 11 such as a CPU (microprocessor), the memory unit 12 such as a ROM and a RAM, and other peripheral circuits, not illustrated, such as an I/O interface.

Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 stores detailed high-precision map information for self-driving. The high-precision map information includes position information of a road, information on a road shape (such as a curvature), information on gradient of a road, position information of intersections and junctions, types and position information of division lines such as white lines, information on number of lanes (driving lanes), lane width and position information of each lane (information on center position of lanes and boundaries of lane positions), position information of landmarks (such as traffic lights, signs, and buildings) serving as marks on the map, and information on road surface profiles such as road surface irregularities. The high-precision map information stored in the memory unit 12 may include high-precision map information acquired from the outside of the subject vehicle via the communication unit 7, or may include high-precision map information created by the subject vehicle itself using detection values of an external sensor group 1 or detection values of the external sensor group 1 and an internal sensor group 2. The memory unit 12 may store programs for various types of control and information such as threshold values used in the programs.

The processing unit 11 includes a subject vehicle position recognition unit 13, an exterior environment recognition unit 14, an action plan generation unit 15, and a driving control unit 16 as functional configurations.

The subject vehicle position recognition unit 13 recognizes a position of the subject vehicle (subject vehicle position) on the map, based on the position information for the subject vehicle that has been obtained by the position measurement unit 4 and the map information in the map database 5. The subject vehicle position may be recognized using the high-precision map information stored in the memory unit 12 and surrounding information of the subject vehicle that has been detected by the external sensor group 1, and thus it becomes possible to recognize the subject vehicle position with high accuracy. The movement information (a moving direction and a moving distance) of the subject vehicle may be calculated based on the detection values of the internal sensor group 2, and the position of the subject vehicle can also be recognized. Note that when the subject vehicle position can be measured by a sensor installed on a road or outside a road side, the subject vehicle position can also be recognized by communicating with the sensor via the communication unit 7.

The exterior environment recognition unit 14 recognizes an external situation around the subject vehicle, based on a signal from the external sensor group 1 such as a camera, a LiDAR, and a radar. For example, a position, a speed, and an acceleration of a surrounding vehicle (a forward vehicle or a rearward vehicle) traveling near the subject vehicle, a position of a nearby vehicle stopped or parked around the subject vehicle, and positions and states of other objects are recognized, and target information is created.

The other objects include a sign, a traffic light, a road, a building, a guardrail, a utility pole, a signboard, a pedestrian, a bicycle, and the like. Indications such as division lines (such as a white line) and stop lines on a road surface are also included in the other objects (roads). The states of other objects include a color (red, green, yellow) of a traffic light, and the moving speed and orientation of a pedestrian or a bicycle. Some of stationary objects among the other objects constitute a landmark serving as an index of the position on the map, and the exterior environment recognition unit 14 also recognizes the position and type of the landmark.

The action plan generation unit 15 generates a driving path (target path) of the subject vehicle from a current time point to a predetermined time ahead, for example, based on a route searched by the navigation unit 6, the high-precision map information stored in the memory unit 12, the subject vehicle position recognized by the subject vehicle position recognition unit 13, and the external situation recognized by the exterior environment recognition unit 14. When a plurality of paths can be present as candidates of the target path on the route searched by the navigation unit 6, the action plan generation unit 15 selects, from among the plurality of paths, an optimal path that satisfies criteria such as compliance with laws and regulations and efficient and safe driving, and generates the selected path as the target route.

Then, the action plan generation unit 15 generates an action plan corresponding to the generated target route. The action plan generation unit 15 generates various action plans corresponding to drive modes, such as overtaking driving for overtaking a preceding vehicle, lane change driving for changing driving lanes, follow driving for following a preceding vehicle, lane keep driving for keeping the lane not to deviate from the driving lane, deceleration driving, or acceleration driving. In generating the target route, the action plan generation unit 15 first determines a drive mode, and then generates the target route, based on the drive mode.

In the self-drive mode, the driving control unit 16 controls each actuator AC such that the subject vehicle drives along the target route generated by the action plan generation unit 15. For example, the driving control unit 16 calculates a requested drive force for obtaining target acceleration for each unit time calculated by the action plan generation unit 15 in consideration of a driving resistance determined according to a road gradient or the like in the self-drive mode. For example, the actuator AC is feedback-controlled such that an actual acceleration detected by the internal sensor group 2 becomes the target acceleration. That is, the driving actuator AC is controlled such that the subject vehicle drives at the target vehicle speed and the target acceleration.

In addition, the driving control unit 16 calculates an optimal steering angle for causing the subject vehicle to follow the target route, based on a vehicle state quantity and the like observed by the internal sensor group 2 and the like in the self-drive mode. Then, a steering angle instruction signal corresponding to the calculated steering angle is output to control the steering actuator AC.

Note that in the manual drive mode, the driving control unit 16 controls each actuator AC in accordance with a drive command (such as a steering operation) from the driver acquired by the internal sensor group 2.

In the lane keep driving, by the way, the steering actuator (hereinafter, also referred to as a steering actuator) is controlled so that the subject vehicle travels while passing through a target position in a lane width direction. However, when a disturbance such as a change in slope of the road surface (a change in gradient in the lane width direction) or a strong crosswind occurs, there is a possibility that the position of the subject vehicle in the lane width direction deviates from the target position, or the orientation of the subject vehicle deviates from the advancing direction. Therefore, in the embodiment, the following steering angle control apparatus is configured to eliminate the positional deviation of the subject vehicle occurring during traveling and the orientation deviation of the subject vehicle occurring during traveling.

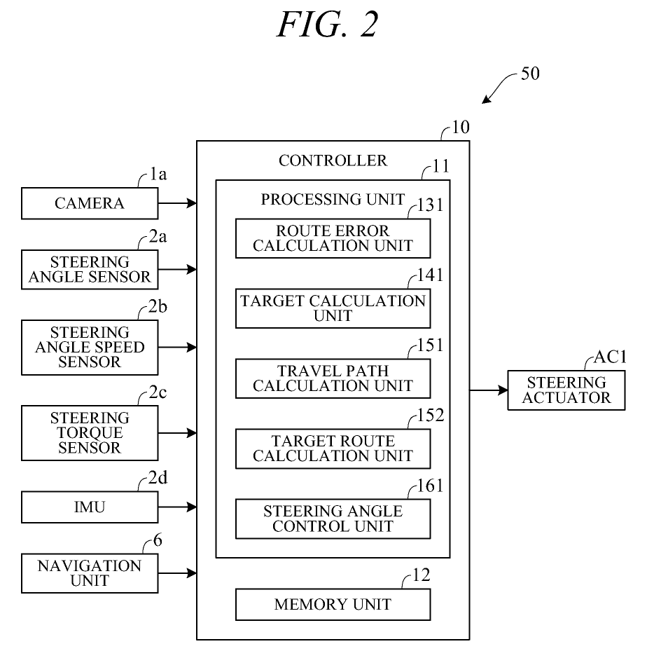

FIG. 2 is a block diagram illustrating a main configuration of a steering angle control apparatus 50 according to the embodiment. As an example, the steering angle control apparatus 50 is configured as a part of the function of the controller 10 in FIG. 1. A camera 1a, a steering angle sensor 2a, a steering angle speed sensor 2b, a steering torque sensor 2c, IMU (Inertial Measurement Unit) 2d, a navigation unit 6, and a steering actuator AC1 are connected to the controller 10. In addition, the steering angle sensor 2a, the steering angle speed sensor 2b, the steering torque sensor 2c, and IMU 2d constitutes a part of the internal sensor group 2 in FIG. 1

The camera 1a is a monocular camera having an imaging element, and constitutes a part of the external sensor group 1 in FIG. 1. The camera 1a may be a stereo camera. The camera 1a is mounted at a predetermined position, for example, in a front part of the subject vehicle, and continuously images a space on a forward side of the subject vehicle to acquire an image (camera image) of a target object. The target object includes a division line or the like that defines a lane on a road. Note that the target object may be detected by a radar, a LiDAR, or the like instead of the camera 1a or together with the camera 1a.

The steering angle sensor 2a detects, for example, a rotation angle (steering angle) of a steering shaft coupled to a steering wheel (not illustrated). The steering angle speed sensor 2b detects a rotation angle speed (also referred to as a steering angle speed) of the steering shaft. The steering torque sensor 2c detects a steering operation by the driver, more specifically, steering torque that acts on the steering wheel. For example, the steering angle detected by the steering angle sensor 2a when the steering wheel is rotated leftward (counterclockwise) from the neutral position is set to a positive value, and the steering angle detected by the steering angle sensor 2a when the steering wheel is rotated rightward (clockwise) from the neutral position is set to a negative value.

IMU 2d detects translational motion and rotational motion in three axial directions of the subject vehicle (X, Y, Z axes) may be provided as one of the internal sensor group 2. The X-axis direction corresponds to the front-rear direction of the subject vehicle, the Y-axis direction corresponds to the lateral leftward direction of the subject vehicle, and the Z-axis direction corresponds to the upward vertical direction.

The controller 10 includes a route error calculation unit 131, a target calculation unit 141, a travel path calculation unit 151, a target route calculation unit 152, and a steering angle control unit 161 as functional configurations which the processing unit 11 (FIG. 1) is responsible for. Furthermore, as described above, the controller 10 includes the memory unit 12.

Note that the route error calculation unit 131 may constitute a part of the subject vehicle position recognition unit 13. The target calculation unit 141 may constitute a part of the exterior environment recognition unit 14. The travel path calculation unit 151 and the target route calculation unit 152 may constitute a part of the action plan generation unit 15. The steering angle control unit 161 may constitute a part of the driving control unit 16.

The route error calculation unit 131 compares the position and orientation of the subject vehicle recognized by the subject vehicle position recognition unit 13 with a target route set by the target route calculation unit 152 to be described later, and calculates a route lateral position deviation and a route heading angle deviation of the subject vehicle with respect to the target route immediately beside the subject vehicle.

The route error calculation unit 131 first recognizes the position and shape of the division line that defines the lane from the camera image of the camera 1a, and recognizes the lane on based on its recognition result. Next, the route error calculation unit 131 compares the recognized position, angle, and shape of the lane with the target route set by the target route calculation unit 152 to be described later, and calculates, as a route lateral position deviation, a deviation amount between the position of the subject vehicle and the position (lane center) on the target route immediately beside the subject vehicle. In addition, the route error calculation unit 131 calculates a deviation amount between the orientation of the subject vehicle and the heading angle of the target route immediately beside the subject vehicle as a route heading angle deviation.

The route error calculation unit 131 may calculate the route lateral position deviation and the route heading angle deviation by using the subject vehicle position and orientation recognized based on the high-precision map information stored in the memory unit 12 and the surrounding information of the subject vehicle detected by the external sensor group 1, or the subject vehicle position and orientation measured by the position measurement unit 4.

The target calculation unit 141 calculates information indicating a target existing around the subject vehicle. The target calculation unit 141 recognizes a target including a moving object such as other vehicle, a bicycle, and a pedestrian, and a stationary object (also referred to as a feature) such as a guardrail or a sign based on signals input from the external sensor group 1 such as the camera 1a, a LiDAR, and a radar, and outputs target information indicating the recognized target.

The travel path calculation unit 151 calculates (searches for) a travel path (referred to as a base travel path) based on the current position of the subject vehicle measured by the position measurement unit 4, the position of the destination input from the driver, and the map information stored in the map database 5. The calculation of the base travel path is similar to the search for the route by the navigation unit 6. The travel path calculation unit 151 may acquire, as the base travel path, the route set by the navigation unit 6 from the navigation unit 6.

The target route calculation unit 152 sets, on the base travel path, a target position in the lane width direction through which the subject vehicle is to pass, based on the base travel path calculated by the travel path calculation unit 151 and the external situation recognized by the exterior environment recognition unit 14. When the subject vehicle is traveling, for example, in the lane keep driving, the target route calculation unit 152 repeatedly sets the target position along the advancing direction. As a result, a target route (a path obtained by connecting the target positions) is generated along the base travel path.

Note that when the exterior environment recognition unit 14 recognizes an obstacle such as a utility pole or a parked vehicle on a forward side in the advancing direction of the subject vehicle, the target route calculation unit 152 sets the target position using the target information output from the target calculation unit 141, so that a distance between the subject vehicle and the obstacle in the lane width direction is not shorter than a certain distance when the subject vehicle passes on a lateral side of the obstacle. In addition, when a lane change instruction is input from the driver via a direction indicator (not illustrated), the target route calculation unit 152 sets the target position so that the traveling position of the subject vehicle gradually moves to the center of the lane which is a change destination, along the advancing direction.

For example, in the case lane keeping assistance capability is enabled, the steering angle control unit 161 controls the steering angle of the subject vehicle via the steering actuator AC1 such that the subject vehicle travels following the target route. Specifically, the steering angle control unit 161 calculates a steering angle necessary for causing the position of the subject vehicle to follow the target route.

The steering angle control unit 161 acquires the target route generated by the target route calculation unit 152. In addition, the steering angle control unit 161 acquires design information regarding the subject vehicle (hereinafter, referred to as vehicle characteristic information) from the memory unit 12. The vehicle characteristic information includes a vehicle mass [kg] of the subject vehicle, a yaw moment of inertia [kgm²], a distance [m] between the center of gravity G and a front axle, a distance lr [m] between the center of gravity G and a rear axle, an equivalent cornering power [N/rad] of one front wheel, an equivalent cornering power [N/rad] of one rear wheel, a stability factor [-], and the like.

Further, the steering angle control unit 161 acquires vehicle state quantities. The vehicle state quantities include a vehicle speed (vehicle body speed) of the subject vehicle, a yaw angle speed (yaw rate), a steering angle (front-wheel steering angle), a gravitational acceleration, a steering angle speed, a vehicle body orientation, and the like obtained from the output value of the sensor constituting the internal sensor group 2 or by calculation using the output value of the sensor. In addition, the vehicle state quantities include a route lateral position deviation, a route heading angle deviation, a yaw angle speed deviation, and the like.

As an example, the vehicle body orientation is calculated based on the extending direction of the target route and the vehicle length direction (sometimes referred to as a longitudinal direction) of the subject vehicle recognized from a camera image of the camera 1a or the like. As described above, the route lateral position deviation is a deviation amount in the lane width direction of the position of the subject vehicle from the target route. The route heading angle deviation is a deviation angle of the orientation (vehicle body orientation) of the subject vehicle with respect to the target route. The yaw angle speed deviation denotes a deviation between the yaw angle speed detected by an IMU 2d included in the internal sensor group 2 and the target yaw angle speed (= vehicle speed × route curvature). The route curvature is a curvature of the target route ahead in the advancing direction of the subject vehicle, and is calculated by the steering angle control unit 161, for example.

The steering angle control unit 161 estimates a state quantity that cannot be observed using the internal sensor group 2 by using a state estimation model to be described later. Specifically, the steering angle control unit 161 estimates the steering angle disturbance δd [rad] and the vehicle body slip angle β [rad], and calculates the effective front-wheel steering angle δ^ [rad] excluding the steering angle disturbance δd. “^” indicates an estimated value. A relationship among the front-wheel steering angle δ, and the effective front-wheel steering angle δ^ and the steering angle disturbance δd is expressed by an equation δ = δ^ + δd. The steering angle disturbance δd is a disturbance component included in the steering angle (observation value) of the subject vehicle, and refers to a steering angle that does not influence the behavior of the subject vehicle, for example, as a counter-steering against a cant angle. The cant angle is a gradient in the lane width direction (road surface cross gradient). The counter-steering caused by crosswinds or a center-point offset of the steering device may be included in the steering angle disturbance δd. The vehicle body slip angle β is a deviation angle between the orientation of the vehicle speed of the subject vehicle and the vehicle body orientation of the subject vehicle.

The steering angle control unit 161 inputs the acquired vehicle state quantities and vehicle characteristic information to the travel simulation model (hereinafter, referred to as a prediction model). Using the prediction model, the steering angle control unit 161 calculates an optimal steering angle (optimal steering angle sequence to be described later) for the future traveling position of the subject vehicle to follow the target route by the model predictive control. The model predictive control is a prior art. The model predictive control is one of control methods for calculating an optimal control input by using predictive estimation of a control target. In the model predictive control, the prediction model and an optimizer that evaluates the operation of the prediction model and calculates an optimal control input are used. The prediction model is a model for representing the control target.

The steering angle control unit 161 extracts a steering angle to be instructed at a preview time ahead from the optimal steering angle sequence, outputs, as a steering angle instruction value, a target steering angle added with the steering angle disturbance (a fusion steering angle disturbance δ12 to be described later) excluded in advance, and controls the steering angle by the steering actuator AC1.

Note that, while the steering angle control based on the target steering angle is being executed, when the steering torque is detected by the steering torque sensor 2c, the steering angle control unit 161 may determine that the steering operation by the driver has been performed (an instruction to change the steering angle has been made) and interrupt the steering angle control based on the above angle instruction value .

In addition, while the steering angle control based on the target steering angle is being executed, the steering angle control unit 161 may continue the steering angle control based on the target steering angle, unless the steering torque sensor 2c detects large steering torque from which the driver's intention to release route-follow driving can be clearly understood, in other words, unless a steering operation of changing the steering angle by a predetermined value or more is performed.

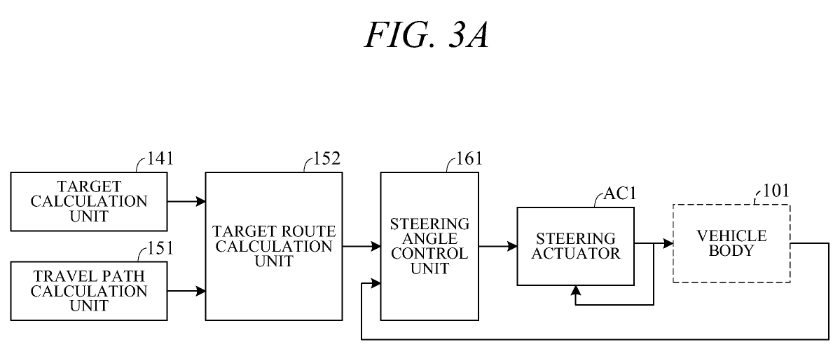

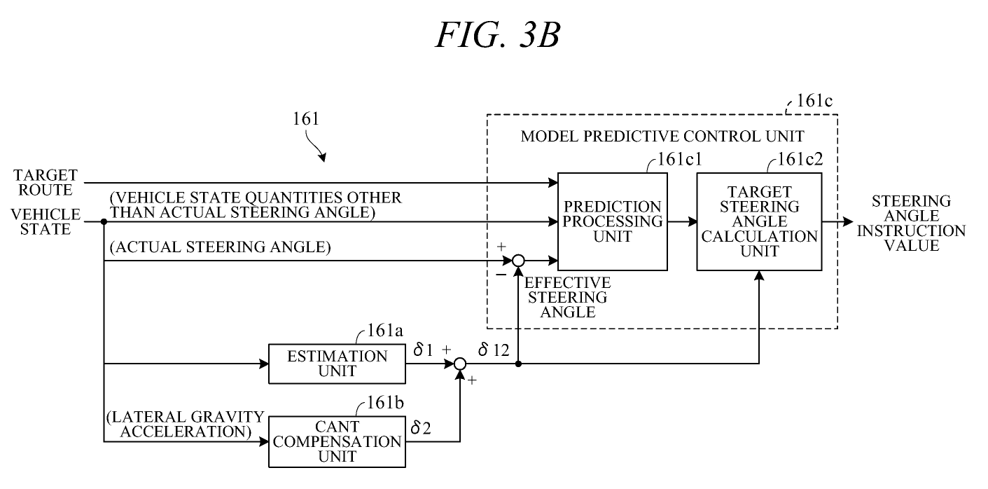

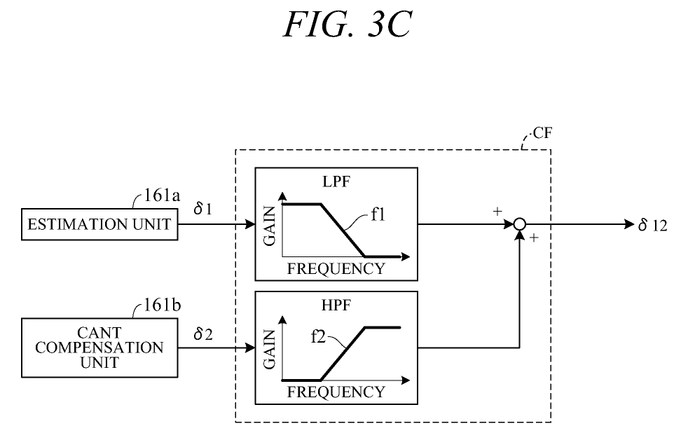

FIG. 3A is a block diagram for explaining a flow of steering angle control by the steering angle control unit 161. In FIG. 3A , in the configuration illustrated in FIG. 2, the target calculation unit 141, the travel path calculation unit 151, the target route calculation unit 152, the steering angle control unit 161, the steering actuator AC1, and a vehicle body of a subject vehicle 101 are illustrated.

FIG. 3B is a block diagram illustrating details of the steering angle control unit 161 in FIG. 3A. The steering angle control unit 161 includes an estimation unit 161a, a cant compensation unit 161b, and a model predictive control unit 161c.

The estimation unit 161a models the vehicle state quantity influenced by factors such as the front-wheel steering angle speed δ' [rad/s], for example, and computes estimated values of the steering angle disturbance δd and the vehicle body slip angle β by the Kalman filter by using these factors, observed vehicle state quantities, and previous estimated values. In addition, in general, the vehicle state quantities actually observed constantly include a noise component (observation noise), and further include a noise component (process noise) indicating model uncertainty. By repeating the estimation computation using the Kalman filter, estimation with the smallest error is performed in consideration of an observation value and the model uncertainty. Hereinafter, the estimated value of the steering angle disturbance δd is referred to as an estimated steering angle disturbance δ1.

The cant compensation unit 161b observes a cant angle. Specifically, the cant compensation unit 161b calculates the cant angle at the traveling position of the subject vehicle 101 based on the lateral component of the gravitational acceleration (hereinafter, referred to as lateral gravity acceleration) included in the vehicle state quantities. The cant compensation unit 161b further predicts an influence of the cant angle (a deviation of the orientation of the subject vehicle with respect to the advancing direction) by feedforward compensation, and calculates a steering angle amount (hereinafter, referred to as a cant compensation steering angle) that cancels the influence.

The model predictive control unit 161c includes a prediction processing unit 161c1 and a target steering angle calculation unit 161c2. The prediction processing unit 161c1 performs a model predictive computation using the target route and the observed vehicle state quantities of the subject vehicle 101 as inputs. By performing the model predictive computation, the prediction processing unit 161c1 performs processing (solution search computation) of calculating an optimal steering angle sequence for several future seconds (prediction horizon) while predicting the speed and the traveling direction (predicted route) of the subject vehicle 101 for several future seconds (prediction horizon) on the model at predetermined computation intervals (for example, several milliseconds to several seconds). The optimal steering angle sequence includes the optimal steering angle predicted in each step according to the sample time. The sample time for each step of the prediction horizon may be adjustable. The prediction processing unit 161c1 outputs the calculation result (optimal steering angle sequence) of the model predictive computation to the target steering angle calculation unit 161c2.

Note that as illustrated in FIG. 3B, the model predictive control unit 161c excludes the estimated steering angle disturbance δ1 calculated by the estimation unit 161a and the cant compensation steering angle δ2 calculated by the cant compensation unit 161b from the steering angle (actual steering angle) included in the vehicle state quantities as the input values of the model predictive computation. As described above, in the model predictive computation of the prediction processing unit 161c1, instead of the actual steering angle, the steering angle (hereinafter, referred to as an effective steering angle) obtained by excluding the estimated steering angle disturbance δ1 and the cant compensation steering angle δ2 from the actual steering angle is used as the input value. δ12 in FIG. 3B represents a value (referred to as a fusion steering angle disturbance) obtained by merging the estimated steering angle disturbance δ1 and the cant compensation steering angle δ2. The model predictive control unit 161c excludes the estimated steering angle disturbance δ1 and the cant compensation steering angle δ2 from the actual steering angle by subtracting the fusion steering angle disturbance δ12 from the actual steering angle.

The target steering angle calculation unit 161c2 inputs the optimal steering angle sequence calculated by the prediction processing unit 161c1 and the fusion steering angle disturbance δ12. The target steering angle calculation unit 161c2 extracts a steering angle to be instructed at a predetermined preview time tp ahead from the optimal steering angle sequence. The target steering angle calculation unit 161c2 adds the fusion steering angle disturbance δ12 to the extracted steering angle for correction. In this manner, the target steering angle is calculated in consideration of the influence of the steering angle disturbance δd. The target steering angle calculation unit 161c2 outputs, to the steering actuator AC1, the calculated target steering angle as a steering angle instruction value after next several milliseconds.

FIG. 3C is a diagram for explaining the fusion steering angle disturbance δ12 of FIG. 3B. As illustrated in FIG. 3C, the estimated steering angle disturbance δ1 output from the estimation unit 161a and the cant compensation steering angle δ2 output from the cant compensation unit 161b are merged via a filter CF. The filter CF is a complementary filter designed such that a sum of gains (amplification factors) of a low-pass filter (LPF) and a high-pass filter (HPF) is 1 in the entire frequency range. Note that a time constant of the complementary filter CF is set according to required responsiveness (responsiveness of steering angle control with respect to a cant change).

The estimated steering angle disturbance δ1 output from the estimation unit 161a is input to the low-pass filter (LPF) according to the gain for the frequency component (a speed of a temporal change) of the estimated steering angle disturbance δ1 as indicated by a characteristic f1. On the other hand, the cant compensation steering angle δ2 output from the cant compensation unit 161b is input to the high-pass filter (HPF) according to the gain for the frequency component (a speed of a temporal change) of the cant compensation steering angle δ2 as indicated by a characteristic f2. The estimated steering angle disturbance δ1 and the cant compensation steering angle δ2, which have been subjected to filtering, are merged (added) as illustrated in FIG. 3C, thereby obtaining the fusion steering angle disturbance δ12.

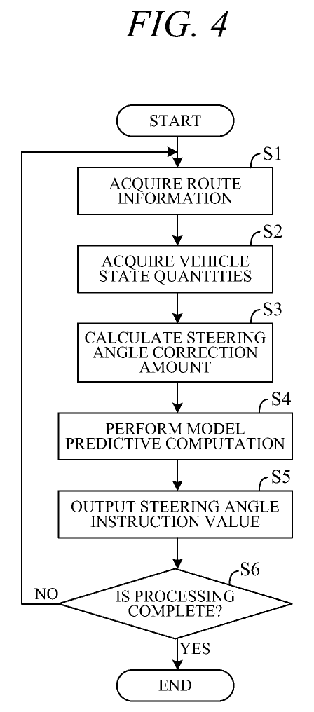

FIG. 4 is a flowchart illustrating an example of computation processing executed by the processing unit 11 of the controller 10 in FIG. 2 according to a program defined in advance. The processing illustrated in the flowchart is repeatedly executed, for example, while the subject vehicle 101 is traveling in the self-drive mode. In addition, the processing is repeatedly executed when the subject vehicle 101 is traveling in the manual drive mode and, for example, the lane keeping assistance capability, which is one of the driving assistance capabilities, is enabled, that is, when the subject vehicle 101 is traveling in the lane keep driving.

In step S1, the controller 10 acquires the target route of the subject vehicle 101. More specifically, the route information indicating the target route generated by the target route calculation unit 152 is acquired. In step S2, the controller 10 acquires the vehicle state quantities from the output value of the sensor constituting the internal sensor group 2 or by calculation using the output value of the sensor.

In step S3, the controller 10 calculates a steering angle correction amount (fusion steering angle disturbance δ12). Specifically, the controller 10 estimates a disturbance component of the steering angle (actual steering angle) included in the vehicle state quantities, and acquires the estimation result as the estimated steering angle disturbance δ1. In addition, the controller 10 calculates a steering angle (cant compensation steering angle) δ2 that compensates for the cant angle, which is a part of the disturbance component of the actual steering angle. The controller 10 calculates the fusion steering angle disturbance δ12 by merging the estimated steering angle disturbance δ1 and the cant compensation steering angle δ2 via the complementary filter CF.

In step S4, the controller 10 calculates an optimal steering angle sequence by performing model predictive computation using the target route acquired in step S1 and the vehicle state quantities acquired in step S2 as inputs. Note that when performing the model predictive computation, the controller 10 corrects (subtracts) the steering angle (actual steering angle) included in the vehicle state quantities as the input values with the fusion steering angle disturbance δ12 calculated in step S3.

In step S5, the controller 10 extracts the steering angle to be instructed at the preview time ahead from the calculation result (optimal steering angle sequence) of the model predictive computation, and calculates a target steering angle by adding the fusion steering angle disturbance δ12 calculated in step S3 to the extracted steering angle. The controller 10 outputs, to the steering actuator AC1, the target steering angle as a steering angle instruction value after next several milliseconds.

In step S6, the controller 10 determines whether or not to end the processing. For example, when the self-drive mode is released, the controller 10 makes an affirmative determination in step S6 and ends the processing according to FIG. 4. On the other hand, when the self-drive mode is continued, the controller 10 makes a negative determination in step S6, returns to step S1, and repeats the above-described processing.

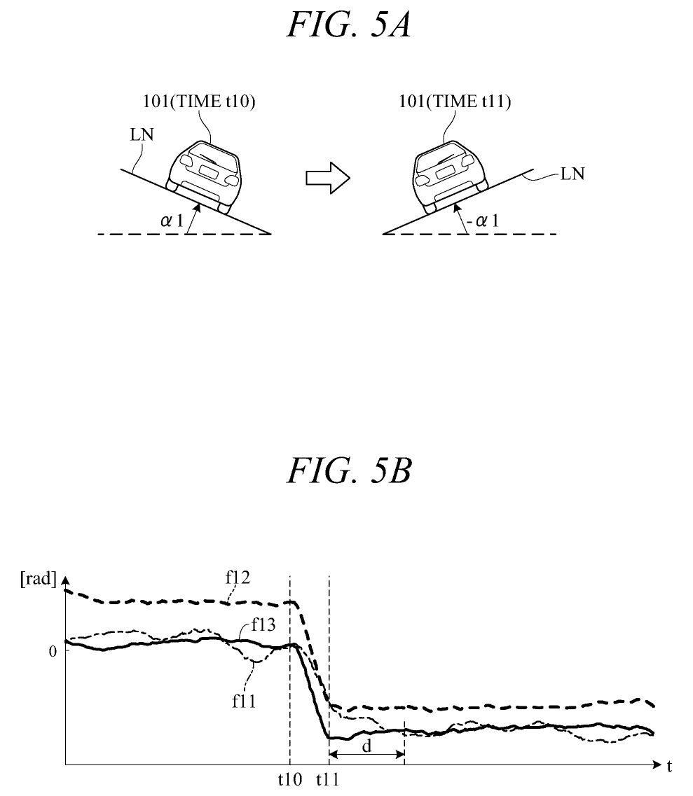

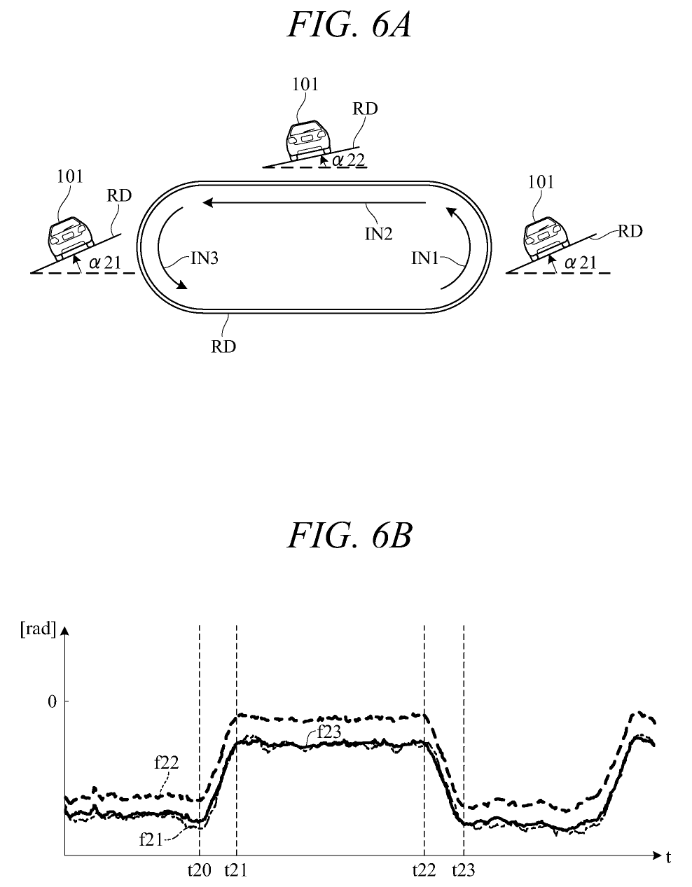

Effects of the present embodiment will be described with reference to FIGS. 5A to 6B. FIG. 5A schematically illustrates a state where the subject vehicle 101 traveling in a lane LN is viewed from behind. As illustrated in FIG. 5A, a gradient in the lane width direction at the traveling position at time t10, that is, the cant is α1%. On the other hand, the cant at the traveling position at time t11 after time t10 is -α1%.

FIG. 5B is a diagram illustrating a steering angle correction amount corresponding to the travel scene of FIG. 5A. A characteristic f11 indicates the estimated steering angle disturbance δ1. A characteristic f12 indicates the cant compensation steering angle δ2. A characteristic f13 indicates the fusion steering angle disturbance δ12 obtained by merging the estimated steering angle disturbance δ1 indicated by the characteristic f11 and the cant compensation steering angle δ2 indicated by the characteristic f12.

The estimated steering angle disturbance δ1 computed using the Kalman filter has high accuracy (data reliability) in a normal state where there is no cant change, but has poor responsiveness to a change in cant in a transient region of cant (time t10 to t11). In the example of FIG. 5B, the response of the estimated steering angle disturbance δ1 to the change in cant is delayed by time d. On the other hand, the cant compensation steering angle δ2 calculated based on the observation value of the cant angle by feedforward compensation has high responsiveness to the cant change as illustrated in FIG. 5B. However, when the cant angle is not 0 even in the normal state (the road surface has a gradient in the lane width direction), an offset occurs in the cant compensation steering angle δ2 so as to compensate for the cant angle. In the example of FIG. 5B, the cant compensation steering angle δ2 in the normal state is shifted to a plus side (upward in the drawing) from the estimated steering angle disturbance δ1.

By merging two steering angle correction amounts (the estimated steering angle disturbance δ1 and the cant compensation steering angle δ2) having such characteristics via the complementary filter CF of FIG. 3C, it is possible to obtain a steering angle correction amount (fusion steering angle disturbance δ12) having high responsiveness to a cant change and high accuracy as indicated by the characteristic f13. By using such a steering angle correction amount to correct the input value (actual steering angle) and the output value (the steering angle to be instructed at a predetermined preview time ahead in the optimal steering angle sequence) of the model predictive computation as illustrated in FIG. 3B, it is possible to improve robustness against cant during route-follow driving. As a result, the subject vehicle 101 can accurately follow the target route in the normal state where there is no transient region of cant and no cant change.

FIG. 6A illustrates a state where the subject vehicle 101 sequentially travels on a curved road IN1, a straight road IN2, and a curved road IN3 of a circling course RD. The cant near the apex of the curved road of the circling course RD is α21%. On the other hand, the cant of the straight road is α22 (< α21) %.

FIG. 6B is a diagram illustrating a steering angle correction amount corresponding to the travel scene of FIG. 6A. A characteristic f21 indicates the estimated steering angle disturbance δ1. A characteristic f22 indicates the cant compensation steering angle δ2. A characteristic f23 indicates the fusion steering angle disturbance δ12 obtained by merging the estimated steering angle disturbance δ1 indicated by the characteristic f21 and the cant compensation steering angle δ2 indicated by the characteristic f22. As indicated by the characteristic f23, even when the vehicle travels on a road with a gentle change in cant like the circling course RD, a steering angle correction amount (fusion steering angle disturbance δ12) with high responsiveness and high accuracy in a transient region of cant (time t20 to t21, t22 to t23) is obtained. As a result, the subject vehicle 101 can accurately follow the target route regardless of how rapidly or gradually the cant angle changes in the transient region of cant.

According to the present embodiment, the following operations and effects are achievable.
(1) A steering angle control apparatus 50 includes: a model predictive control unit 161c that acquires vehicle state quantities indicating a motion state of a subject vehicle 101 based on a sensor value of an in-vehicle sensor, predicts a behavior of the subject vehicle 101 based on the acquired vehicle state quantities, and calculates a steering angle instruction value for a steering actuator AC1 using a prediction result so as to maintain a traveling state where the subject vehicle 101 travels along a target route; an estimation unit 161a that estimates a disturbance component of a steering angle included in the vehicle state quantities and calculates an estimated steering angle disturbance δ1 as a first steering angle correction amount based on an estimation result; and a cant compensation unit 161b that calculates a steering angle that compensates for a cant angle of a road surface, which is a part of the disturbance component, based on the vehicle state quantities, and calculates a cant compensation steering angle δ2 as a second steering angle correction amount based on a calculation result. The model predictive control unit 161c corrects the steering angle (actual steering angle) included in the vehicle state quantities used for prediction of the vehicle behavior, based on a fusion steering angle disturbance δ12 as a third steering angle correction amount obtained by merging the estimated steering angle disturbance δ1 and the cant compensation steering angle δ2. In addition, the model predictive control unit 161c as steering angle instruction unit outputs, to the steering actuator AC1, the steering angle instruction value corrected based on the fusion steering angle disturbance δ12. The disturbance component of the steering angle included in the vehicle state quantities includes at least one of a steering angle (counter-steering) that compensates for the cant angle of the road surface or a steering angle (counter-steering) that compensates for a center-point offset of the steering device of the subject vehicle 101. Accordingly, it is possible to improve the responsiveness of the steering angle control to the change in the road surface condition. As a result, the subject vehicle 101 can appropriately travel along the target route even in a travel scene where the cant changes within the same lane or a travel scene where the vehicle straddles road surfaces with different cants due to a lane change or the like. In addition, when the subject vehicle 101 is traveling in a lane having a constant cant over a predetermined distance, the subject vehicle 101 can appropriately travel along the target route. As described above, the subject vehicle 101 can accurately follow the target route in both the transient region of cant and the normal state where there is no cant change.
(2) The model predictive control unit 161c changes a ratio for merging the estimated steering angle disturbance δ1 and the cant compensation steering angle δ2, based on a degree of change in the cant angle with respect to time at the traveling position of the subject vehicle 101. Specifically, the model predictive control unit 161c merges the estimated steering angle disturbance δ1 and the cant compensation steering angle δ2 such that a ratio of the cant compensation steering angle δ2 included in the fusion steering angle disturbance δ12 increases as the degree of change in the cant angle with respect to time increases. Accordingly, the steering angle can be appropriately controlled according to the degree of change in cant.
(3) The estimation unit 161a estimates the disturbance component of the steering angle included in the vehicle state quantities by a Kalman filter, based on the vehicle state quantities acquired based on the sensor value of the in-vehicle sensor. Accordingly, it is possible to improve following accuracy with respect to the target route in the normal state where there is no cant change.
(4) The cant compensation unit 161b calculates a steering angle that compensates for the cant angle by feedforward compensation, based on the vehicle state quantities. Accordingly, it is possible to improve the following accuracy with respect to the target route in the transient region of the cant.

The above embodiments may be modified into various modes. Hereinafter, modifications will be described. In the above embodiments, the model predictive control unit 161c as an acquisition unit acquires, as the vehicle state quantities, the vehicle speed of the subject vehicle, the yaw angle speed (yaw rate), the front-wheel steering angle, the acceleration, the steering angle speed, the vehicle body orientation, the route lateral position deviation, the route heading angle deviation of the vehicle body, the yaw angle speed deviation, the vehicle body slip angle, and the like. However, the acquisition unit may acquire, as the vehicle state quantities, a state quantity other than the above.

In the above embodiment, the estimation unit 161a estimates the disturbance component of the steering angle included in the vehicle state quantities by the Kalman filter, based on the vehicle state quantities. However, the estimation unit 161a may estimate the disturbance component of the steering angle included in the vehicle state quantities by using a state estimation method other than the Kalman filter.

Furthermore, in the above embodiments, the fusion steering angle disturbance δ12 is calculated by merging, via the complementary filter CF, the estimated steering angle disturbance δ1 calculated by the estimation unit 161a as a first correction amount calculation unit and the cant compensation steering angle δ2 calculated by the cant compensation unit 161b as a second correction amount calculation unit. However, the method of calculating the fusion steering angle disturbance δ12 is not limited thereto. That is, the estimated steering angle disturbance δ1 and the cant compensation steering angle δ2 may be merged using a means other than the complementary filter.

The above embodiment can be combined as desired with one or more of the aforesaid modifications. The modifications can also be combined with one another.

According to the present invention, it is possible to improve the path-following performance of steering angle control with respect to the change in the road surface condition.

Above, while the present invention has been described with reference to the preferred embodiments thereof, it will be understood, by those skilled in the art, that various changes and modifications may be made thereto without departing from the scope of the appended claims.

What is claimed is:

1. A steering angle control apparatus comprising:
a microprocessor; and
a memory connected to the microprocessor, wherein
the microprocessor is configured to perform:
acquiring vehicle state quantities indicating a motion state of a vehicle based on a sensor value of an in-vehicle sensor;
predicting a behavior of the vehicle based on the vehicle state quantities acquired;
calculating a steering angle instruction value for a steering actuator of the vehicle using a result of the predicting so as to maintain a traveling state where the vehicle travels along a target route;
estimating a disturbance component of a steering angle of the vehicle based on the vehicle state quantities;
calculating a first steering angle correction amount based on a result of the estimating;
calculating a steering angle compensating for a cant angle of a road surface based on the vehicle state quantities, the steering angle compensating for the cant angle being a part of the disturbance component; and
calculating a second steering angle correction amount based on a result of the calculating of the steering angle, wherein
the microprocessor is configured to perform
the predicting including correcting the steering angle included in the vehicle state quantities used for prediction of the vehicle behavior, based on a third steering angle correction amount obtained by merging the first steering angle correction amount and the second steering angle correction amount, and
the microprocessor is configured to further perform
outputting, to the steering actuator, the steering angle instruction value corrected based on the third steering angle correction amount.

2. The steering angle control apparatus according to claim 1, wherein
the microprocessor is configured to perform
the predicting including changing a ratio for merging the first steering angle correction amount and the second steering angle correction amount, based on a degree of change in the cant angle with respect to time.

3. The steering angle control apparatus according to claim 1, wherein
the microprocessor is configured to perform
the predicting including merging the first steering angle correction amount and the second steering angle correction amount such that a ratio of the second steering angle correction amount included in the third steering angle correction amount increases as a degree of change in the cant angle with respect to time increases.

4. The steering angle control apparatus according to claim 1, wherein
the microprocessor is configured to perform
the calculating of the first steering angle correction amount including estimating the disturbance component by a Kalman filter, based on the vehicle state quantities.

5. The steering angle control apparatus according to claim 1, wherein
the calculating of the second steering angle correction amount including calculating a steering angle compensating for the cant angle by feedforward compensation, based on the vehicle state quantities.

6. The steering angle control apparatus according to claim 1, wherein
the disturbance component includes at least one of a steering angle compensating for the cant angle and a steering angle compensating for a center-point offset of a steering device of the vehicle.
